(19) United States
(12) Patent Application Publication
(10) Pub. No.: US 2005/0268308 A1
(43) Pub. Date: Dec. 1, 2005

(54) System and method for implementing a general application program interface

(75) Inventors: Haitao Tang, Helsinki (FI); Petteri Poyhonen, Helsinki (FI)

Correspondence Address: FOLEY & LARDNER, 321 NORTH CLARK STREET, SUITE 2800, CHICAGO, IL, 60610-4764, US

(73) Assignee: Nokia Corporation

(21) Appl. No.: 10/857,157

(22) Filed: May 28, 2004

(51) Int. Cl. G06F 9/46

(52) U.S. Cl. 719/328

(57) ABSTRACT

Systems and methods relating to an application program interface (API) are disclosed. The method relates to a computer implemented method of attaching an application to a generic API. The method includes receiving a mapping request in an API, the mapping request having been triggered by an application, selecting one or more candidate mapping modules from a group of mapping modules registered with the API, accessing at least one of information and rules indicative of an association between the application and one or more mapping modules, and selecting one or more target mapping modules for use with the application based on the information and rules.

### FIELD OF THE INVENTION

The present invention is related to software. More particularly, the present invention relates to a system and a method for providing a generic application program interface.

### BACKGROUND OF THE INVENTION

An application program provides computing devices with the capability to perform a wide variety of tasks including drafting documents, communicating with others, preparing presentations, locating information, etc. An application program is an organized list of instructions that, when executed, cause the computer to behave in a predetermined manner. Processing to prepare an application program for execution may include the use of an assembler, a compiler, an interpreter, or a translator depending on the implementation language.

An Application Program Interface (API) is a formalized set of software calls and routines that can be referenced by an application program in order to access the supporting system or network services. The API is the specific method prescribed by a computer operating system or by an application program by which a programmer in writing an application program makes requests of the operating system or of another application program. The API generally also receives requests from the operating system or another application program and routes these requests to the appropriate application program.

The operating system is the low-level software installed on a computer to handle the interface to peripheral hardware, to schedule tasks, to allocate memory, and to present a default interface to the user when no application program is running. The kernel is the core part of the operating system that is responsible for resource allocation, for low-level hardware interfacing, for security, etc. The operating system makes the resources available to application programs using functions collectively known as the API. The functions are often grouped in terms of what resource or service is provided to the application programmer. Thus, for example, an API may be directed to the computing systems security services. For example, the Security Services API provides application programmers with uniform access to security services atop a variety of underlying cryptographic mechanisms by providing a layer of abstraction over security mechanisms that perform authentication, message integrity protection, and message privacy protection.

Application programs request resources by calling individual API functions. API functions also serve as the means by which messages and information provided by the operating system are relayed back to the application program. The API is defined at the source code level and provides a level of abstraction between the application program and the kernel or other application programs to ensure the portability of the code from one machine to another, and thus, provide platform independence. An API can also provide an interface between a high level language and lower level utilities and services that were written without consideration for the calling conventions supported by the high level language. In this case, the API's main task may be the translation of parameter lists from one format to another and the interpretation of call-by-value and call-by-reference arguments in one or both directions. The calling convention is the arrangement of arguments for a procedure or function call such that the data transferred through the interface maps to the proper parameter. Different programming languages may require arguments to be pushed onto a stack or entered in registers in left-to-right or right-to left order, and either the caller or the callee may be responsible for removing the arguments from the stack or register in the proper sequence. The calling convention also determines if a variable number of arguments is allowed.

The API provides common functionality to satisfy specific underlying needs. Use of an API reduces the programming time and increases the reliability of application programs by providing a common interface to what may be an unknown operating system or application program to which the API interfaces. Thus, an API hides complexities from and provides portability and broader use of application programs across different computing devices with different software and hardware configurations.

A generic API provides common functionality that has been implemented to satisfy specific underlying needs. These generic APIs provide a common starting point for specific application implementations thus reducing the programming time and increasing the reliability of specific implementations built from the generic API. In the past, generic APIs have been developed to satisfy specific application areas by industry groups. For example, the Generic Security Services Application Program Interface (GSS-API) offers application programmers uniform access to security services atop a variety of underlying cryptographic mechanisms. The GSS-API provides a layer of abstraction over security mechanisms that perform authentication, message integrity protection, and message privacy protection. The GSS-API allows a caller application to authenticate a principal identity, to delegate rights to a peer, and to apply security services such as confidentiality and integrity on a per-message basis.

What is needed, however, is a common method to attach any implementation to a generic API rather than only a specific application area such as security services. What is further needed is a common method to select a specific API implementation when there are several implementations available for the same purpose.

### SUMMARY OF THE INVENTION

An exemplary embodiment of the invention relates to a computer implemented method of attaching an application to a generic Application Program Interface (API). The method includes receiving a mapping request in an API, the mapping request having been triggered by an application, selecting one or more candidate mapping modules from a group of mapping modules registered with the API, accessing at least one of information and rules indicative of an association between the application and one or more mapping modules, and selecting one or more target mapping modules for use with the application based on the information and rules.

Another embodiment of the invention relates to an Application Program Interface (API) system. The system includes a module registry adapted to manage attachment, detachment and tracking of mapping modules associated with one or more applications, and a mapping module selector adapted to facilitate selection of one or more of the mapping modules in response to a mapping request triggered by an application.

Another embodiment of the invention relates to an electronic device having one or more application programs, a processor adapted to execute the application programs and an application program interface (API). The API includes a module registry adapted to manage attachment, detachment and tracking of mapping modules associated with one or more applications, and a mapping module selector adapted to facilitate selection of one or more of the mapping modules in response to a mapping request triggered by an application.

Other principal features and advantages of the invention will become apparent to those skilled in the art upon review of the following drawings, the detailed description, and the appended claims.

### BRIEF DESCRIPTION OF THE DRAWINGS

The exemplary embodiments will hereafter be described with reference to the accompanying drawings, wherein like numerals will denote like elements.

FIG. 1 is block diagram illustrating an exemplary computer system according to an embodiment of the invention;

FIG. 2 is a block diagram illustrating an API arrangement according to an embodiment of the invention;

FIG. 3 is a diagrammatic illustration of a mapping module selection process according to an embodiment;

FIG. 4 is a flow chart illustrating the mapping module selection process of FIG. 3 in greater detail;

FIG. 5 is a flow chart illustrating an embodiment of a module detachment process; and

FIG. 6 is a flow chart illustrating an embodiment of a module attachment process.

### DETAILED DESCRIPTION OF THE PREFERRED EMBODIMENTS

An API provides a level of abstraction between the application and the kernel or other application programs and lower level utilities and services that facilitates the portability of the software from one computing device to another. The API is used by a programmer in writing an application program to define the interface to the operating system or another application program or system service without needing to understand the details of the operating system, application program, or system service. These elements may be implemented in different forms, but the programmer need only be concerned with the interface. Thus, the programmer focuses on the information that is required as an input to the API and the information that is output from the API.

A generic API is a generalized API that provides a few, very generalized operations and parameters. These operations generally include, but are not limited to, operations to generate and to handle error codes and operations to handle generic event services that notify applications about module or API generated events. The API may provide a generic portion to deliver a set of implementation-specific parameters.

Quality of service (QoS) allows network administrators to use their existing resources efficiently and to guarantee that critical applications receive high-quality service without having to expand as quickly, or even over-provision, their networks. QoS operates across the network and allocates resources, such as bandwidth, to applications. This allocation is determined by giving some applications priority over other kinds of applications. QoS gives administrators control over their networks, and, consequently, the ability to provide better service to their customers. For example, a mission-critical application can be guaranteed the resources to complete its transactions within an acceptable period of time. Applications that require some level of QoS can be roughly categorized as either qualitative or quantitative applications. Quantitative applications have explicit requirements for how much QoS they need. Qualitative applications require some level of QoS, but the network administrator must decide how much they need to perform correctly. Two common types of quantitative applications are video streaming and IP telephony. Video streaming requires enough bandwidth so that packet loss will not degrade the image. It may also be desirable to clearly identify this traffic to block it from some parts of the network, such as low-capacity links. An MPEG-2 stream, for instance, might require 4 megabits per second (Mbps) of bandwidth. IP telephony is the classic example of a latency-intolerant application. Unless the conversation preserves its real-time character, the service is, from a customer's viewpoint, unusable. Qualitative applications require some level of QoS, but administrators must decide how those requirements will be satisfied. ERP applications, such as SAP, fall into this category. The traffic they generate does not occur in a continuous stream but is a series of transactions that occurs over a period of time. A common requirement is some sort of latency guarantee, so that a group of transactions occurs in a second, for example. How this requirement is met is up to the administrator.

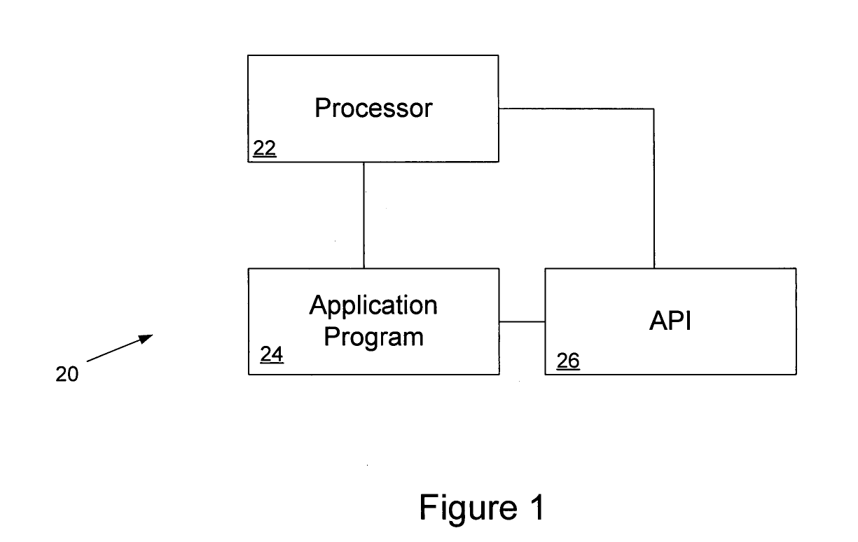

FIG. 1 illustrates a system in which an API according to an embodiment of the present invention may be implemented. The system 20 may be a computer system or any of a number of devices containing a processor and an operating system. The system 20 includes a processor 22 which executes instructions from one or more application programs 24, an API 26, and other devices, modules or other software, in addition to other instructions contained within the processor 22 itself. Application programs 24 may be opened for execution after a user requests that a terminal, such as a mobile device, launch the application program 24. The application program 24 and the API 26 may be executed by the same processor 22. Alternatively, the application program 24 and the API 26 may be executed by different processors. The application programs 24 and the API 26 may be written in the same or different computer languages including, but not limited to high level languages, scripting languages, and assembly languages, etc. Additionally, the application programs 24 and the API 26 operations may be carried out by a special purpose computer, logic circuits, or hardware circuits. Thus, the application programs 24 and the API 26 may be implemented in hardware, firmware, software, or any combination of these methods.

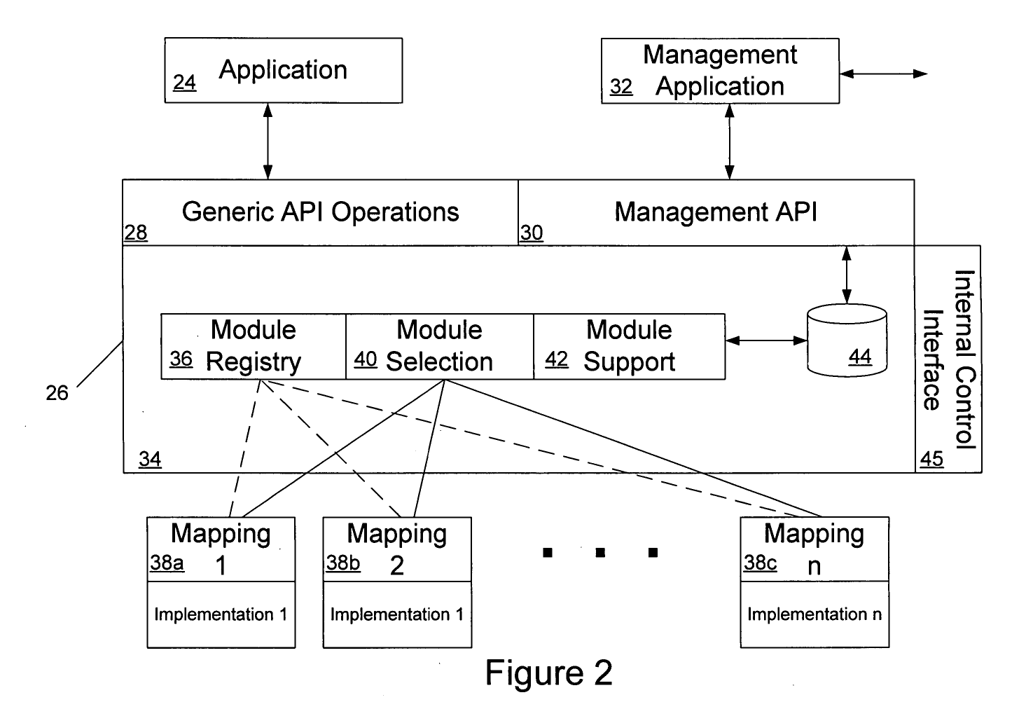

FIG. 2 illustrates an arrangement of an API according to an embodiment of the present invention. In this arrangement, the API 26 includes a variety of components for facilitating the operation of specific functions relating to the management and selection of an appropriate implementation for the application program 24. Applications, such as application program 24 and management application 32, are applications only from the perspective of the API 26. For example, the applications 26, 32 may be traditional applications, such as web browser, or software components in an Open System Interconnection (OSI) layer, such as data link or network layers.

The API 26 includes a generic operations module 28 to provide a set of generic services. As described above, such services may be context-specific services. The generic operations module 28 makes these services available to one or more application programs, such as application program 24.

A management API module 30 is provided within the API 26. The management API module 30 interfaces with one or more management applications, such as management application 32, to input data that may be required by the API 26 for management of various functions provided by the API 26.

The illustrated embodiment of the API 26 provides support for the management and selection of implementations of the application program 24. In one embodiment, the API 26 contains routines to perform the various management and selection functions. Specifically, the illustrated embodiment includes routines for mapping module registry 36, mapping module selection 40 and mapping support 42. The various implementations may be represented through one or more mapping modules 38a-c associated with each implementation.

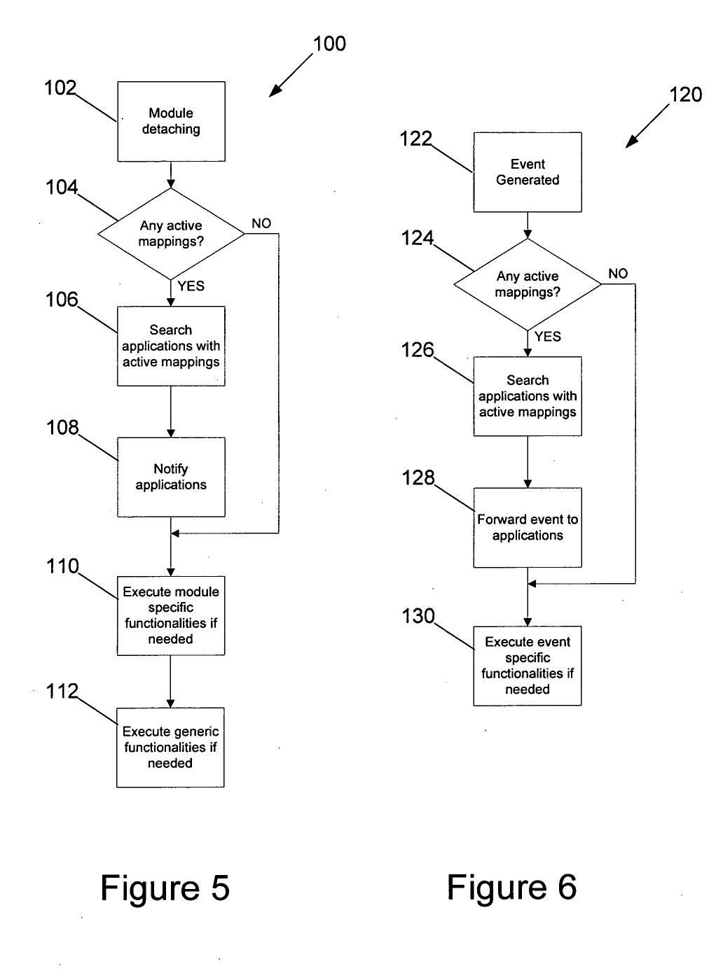

The mapping module registry routine 36 provides management of the mapping modules 38a-c. For example, the mapping module registry routine 36 may manage the attachment and detachment of the mapping modules 38a-c, as described in detail below with reference to FIGS. 5 and 6. In this regard, once a relationship or an association is established between a registered mapping module 38a-c and an application program, such as application program 24, the mapping module registry routine 36 provides mapping module status and alerts to the application programs. Thus, as shown by the dashed lines in FIG. 2, the mapping module registry routine 36 may, either directly or indirectly, monitor each mapping module 38a-c.

Since the specific implementations are not part of the generic API, a mapping module 38a-c is provided to mapping between the relevant generic API operations and the operations of the specific implementation. The mapping modules 38a-c may be added, or attached, when the specific implementation becomes available. Similarly, when a particular implementation is removed, one or more mapping modules 38a-c may also be removed, or detached. When the specific implementation becomes available or is removed, the mapping module registry routine 36 updates the status of the corresponding mapping modules 38a-c as, for example, available or unavailable. All associated application may be notified as well. Thus, the mapping module registry routine 36 provides for easy attachment or detachment of the mapping modules 38a-c via a unified interface and enables and easy adaptation of new types of implementations without interfering with existing ones.

The API 26 may also provide transparent switching between mapping modules 38a-c when, for example, an application requests. The mapping modules 38a-c may facilitate the transparent switching process by providing information concerning changes in state, such as an upcoming inability to serve any applications. In order to support the transparent switching, the API may require sufficient information to select a new mapping module 38a-c. An internal control interface 45 is provided within the API 26 to provide a system interface offering sufficient services for the entities in the API 26 to request various system state information, as needed.

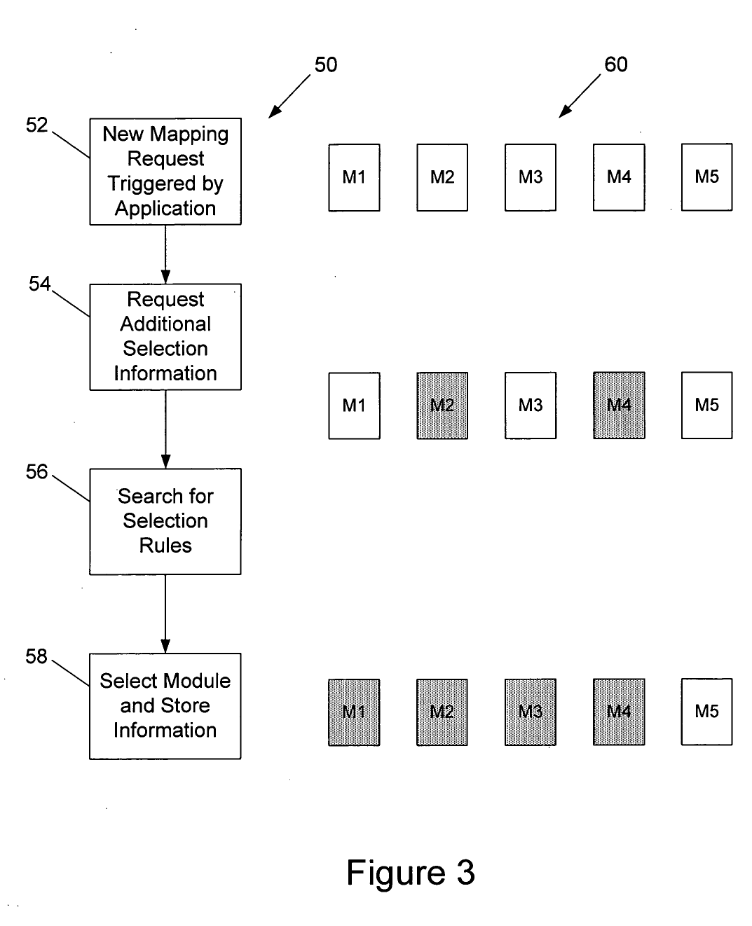

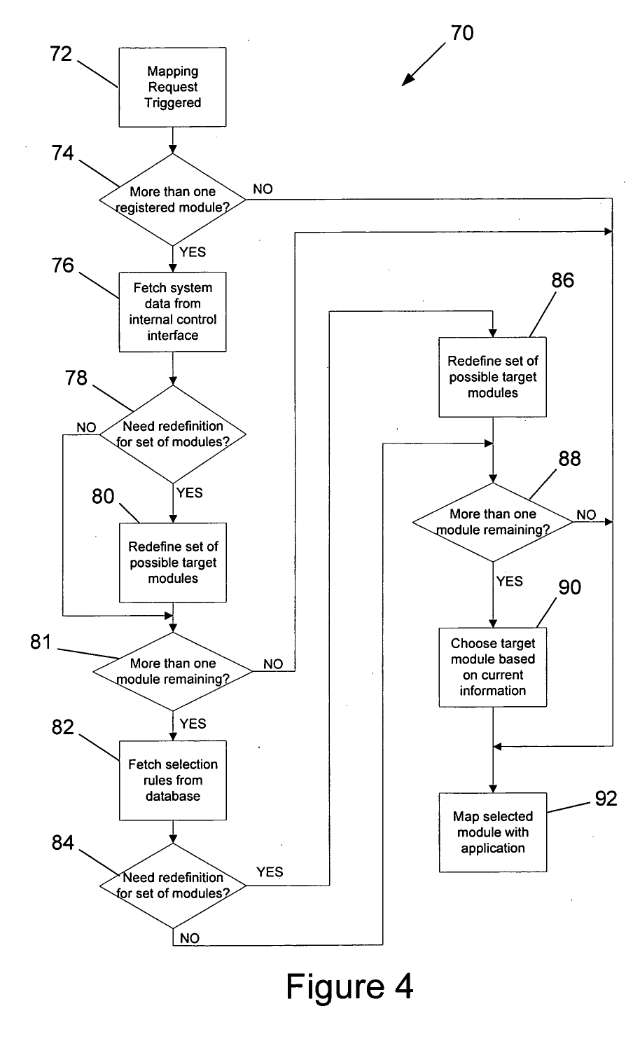

The mapping module selection routine 40 provides for the selection of appropriate mapping modules 38a-c for the application program 24. The selection by the mapping module selection routine 40 associates one or more mapping modules 38a-c with the application program 24, thereby selecting a specific implementation. In this regard, an embodiment of the selection process is described below with reference to FIGS. 3 and 4.

The mapping module selection routine 40 may operate based on a set of rules. The rules may be specified and dynamically updated by a management application, such as management application 32, through the management API module 30. The rules may be expressed through text-based encoding which can be parsed for dynamic selection in run-time, or they may be binary rules that are executable in certain runtime environments. Once received, the rules may be stored in an internal or external data store from the API perspective, such as a database 44.

The rules may be dynamically fetched from either an internal or an external entity, such as a data storage, by the management application 32 during the module attachment process. For example, the attaching mapping module 38a-c may provide sufficient information to allow the management application to determine what to fetch and from where.

The mapping module selection routine 40 can thus apply specified rules to select a mapping module based on certain inputs. The structure of the rules may be selected according to specific needs and desires. Each mapping module 38a-c may use a different structure. An exemplary structure is provided below:

switch(<app-expression>){
case <expression 1>: Action 1
case <expression 2>: Action 2
case <expression 3>: Action 3
case <expression 4>: Action 4
default: Action d
}

Each “Action” may be a sequence of codes or steps. Thus, provided with the default “Action,” the structure provides a selection result for each given expression. Based on the parsed expressions and actions, a run-time selection may be generated and installed. For example, the “app-expression” in the above example may be “streaming, bandwidth=96 kbps, no-extra-payment-for-transport.” Thus, the filled structure may be expressed as:

```
      switch(<streaming, bandwidth = 96kbps, no-extra-
payment-for-transport>){
      case < no-extra-payment-for-transport >:
        if WLAN is available
          <select WLAN>
        else
          <indicate selection failure>
        end
        case ”bandwidth>256kbps”: Action 2
        default: <indicate selection failure>
        }
```

Thus, the complexity of the selection rules may be maintained outside the generic API. Further, the selection rules can be updated dynamically and can be applied at the next selection opportunity.

Referring again to FIG. 2, the mapping support 42 is provided to work with the mapping module 38a-c associated with the specific implementation to associate various operations of the generic API to the specific implementation. In this regard, the mapping support 42 may be adapted to access a database 44 or other data store for information relevant to the mapping. The database 44 may be internal or external to the API 26. Thus, when a new implementation is added and a new mapping module 38a-c is attached, the mapping module 38a-c may associate the operations specified for the specific implementation with existing operations of the generic API listed in the database 44. If the mapping support 42 notices that not all operations can be associated between the mapping module 38a-c and API operations, the mapping support 42 may serve as an association proxy between them to realize the associations from the perspectives of both API and mapping module 38a-c.

Referring now to FIG. 3, an example of a single mapping module selection process will be described. It should be noted that a selection of a multiple mapping modules is also possible and supported, for example, for load-balancing purposes. Such a selection process 50 may be implemented in and performed by the mapping module selection routine 40 described above with reference to FIG. 2. The process 50 is shown in the left side of FIG. 3, along with a resulting set of mapping modules 60 shown on the right side of FIG. 3. The process 50 begins when a new mapping request is triggered by an application (block 52). This may result in the identification of one or more mapping modules being identified. For example, FIG. 3 illustrates an example in which five modules, M1-M5, are identified as candidates.

The process 50 then requests additional selection information to narrow the possibilities (block 54). The request may be sent to an internal control interface adapted to provide system state information. The system state information may, for example, provide the context for the selection, thereby allowing certain candidate modules to be eliminated as possibilities. This system state information may include, for example, a status of interface corresponding on each mapping module 38a-c, so that all mapping modules with disabled or inactive interfaces may be eliminated in the selection process. In the illustrated example, mapping modules M2 and M4 are eliminated at this point as possibilities.

The process 50 then searches for stored selection rules (block 56). As noted above, the selection rules may be stored either within the API or in an external data store.

Based on the selection rules, a single mapping module may be selected for the specific implementation (block 58). In the illustrated example, mapping module M5 is selected. Once the selection is made, the selection information associating the implementation with the selected mapping module may be stored for future use.

In certain embodiments, it may be possible that multiple mapping modules are selected for the use of an application if it is indicated that it has multi-module support.

If the selection process, such as that illustrated in FIG. 3, results in multiple mapping modules (i.e., selection rules were unable to select a single candidate), the assistance of the application may be requested to facilitate selection of a single mapping module. Alternatively, a set of default preferences may be applied to select one of the remaining modules.

FIG. 4 illustrates the process described above in greater detail. It is noted that the described process is illustrated for exemplary purposes only and, depending on the implementation, other steps may be performed as a part of the process. Further, the ordering of the steps may be varied for various embodiments. Such variations are contemplated within the scope of the present invention.

The process 70 begins when a mapping request is triggered by an application (block 72). At block 74, a determination is made as to whether more than one module has been registered for the application. If the determination is made that only one module is registered, the lone module is selected (block 92), and the process is completed.

If the determination at block 74 indicates that more than one mapping module exists as candidates for the specific implementation of the application, the process proceeds to block 76 and obtains system data through an internal control interface. Based on the information obtained at block 76, a determination is made whether the set of candidate mapping modules requires redefinition (block 78). If a redefinition is required, the criteria for candidate module is redefined (block 80) and the process proceeds to block 81. If the determination at block 78 indicates no need for redefinition, then the process skips block 80 and proceeds to block 81.

At block 81, a determination is made as to whether more than one candidate modules remain. If the determination indicates only one remaining module, the process 70 may make the selection of the lone module (block 92), and the process terminates.

If the determination at block 81 indicates that more than one candidate mapping modules remain, the process 70 searches for and obtains selection rules (block 82). As noted above, the selection rules may be stored internal to the API or in an external data store, such as a database.

Based on the search rules obtained at block 82, a determination is made whether the set of candidate mapping modules requires redefinition (block 84). If a redefinition is required, the criteria for candidate module is redefined (block 86) and the process proceeds to block 88. If the determination at block 84 indicates no need for redefinition, then the process skips block 86 and proceeds to block 88.

At block 88, the process determines whether more than one mapping module remains as a candidate for the application. If the determination is made that only one candidate remains, the process continues to block 92 and selects the lone mapping module. If more than one mapping module remains a candidate at block 88, the process 70 proceeds to block 90, where a single mapping module is selected as the best target based on the information available. Thus, a selection is made of a single mapping module for a specific implementation.

FIG. 5 illustrates an embodiment of a process for the detachment of a mapping module. Such a process may be executed by the mapping module registry routine 36 shown in FIG. 2. The process 100 begins when a detachment is requested or is detected by the API (block 102). A determination is made as to whether the module to be detached has any active mappings (block 104). Active mappings may include accessing of the mapping module by one or more applications in addition to the application requesting detachment, for example.

If no active mappings are determined to exist, the process 100 proceeds to block 110. If active mappings are determined to exist at block 104, the process 100 performs a search for applications with active mappings (block 106). Each application having an active mapping is then notified through, for example, an alert that the mapping module is being detached (block 108).

At block 110, the process executes module-specific functionalities. For example, functionalities specific to the mapping module may include a controlled cache purging. Thus, when a module is detaching, the cache associated to the detaching module may be further processed and not ignored.

At block 112, the process executes generic functionalities. The generic functionalities are common for all mapping modules. These may include deregistering of the mapping module, for example.

FIG. 6 illustrates an embodiment of a process for the generation of an event, such as the attachment or detachment of a mapping module. As with the process described above with reference to FIG. 5, the process 120 may be executed by the mapping module registry routine 36 shown in FIG. 2. The process 120 begins when an event is requested or is detected by the API (block 122). The event may be generated by a module, as may occur during an attachment or detachment of a module.

In other embodiments, the event may be generated by an application. For example, if a QoS application determines that a parameter has either exceeded or been reduced below a predetermined threshold, the application may generate an event to be forwarded to other applications. The event may allow or instruct the other applications to adjust their functionality to accommodate the changes in the value of the parameter.

A determination is made as to whether the mapping module generating the event or a mapping module associated with the event generated by an application has any active mappings (block 124). If no active mappings are determined to exist, the process 120 terminates. If active mappings are determined to exist at block 124, the process 120 performs a search for applications with active mappings (block 126). The event is then forwarded to each application having an active mapping (block 128).

At block 130, the process executes event-specific functionalities. These functionalities may be specific to the event and to the mapping module. Thus, if two modules generate the same event, the process may execute different functionalities based on the different modules. For example, if an event is indicative of an interruption in a data stream to an ongoing stream application, a compressor/decompressor (codec) used by the application may react differently than other codecs. Some codecs may adapt to the interruption, while other codecs may request the application to switch to a different codec. Thus, a different mapping module is required for each codec.

It is noted that terms such as “module” or “routine” are used herein with reference to certain embodiments. It will be understood by those skilled in the art that such terms may, in other embodiments, refer to implementations of the invention in hardware, software, firmware or other. Further, functions performed by a module or a routine may be divided so as to be performed by two or more modules or routines. Similarly, functions performed by two or more modules or routines may be combined so as to be performed by a single module or routing. All such variations are contemplated within the scope of the invention.

While particular embodiments of the present invention have been disclosed, it is to be understood that various different modifications and combinations are possible and are contemplated within the true spirit and scope of the appended claims. There is no intention, therefore, of limitations to the exact abstract and disclosure herein presented.

1. A computer implemented method of attaching an application to a mapping module using generic Application Program Interface (API), the method comprising:
a) receiving a mapping request in an API, said mapping request having been triggered by an application;
b) selecting one or more candidate mapping modules from a group of mapping modules registered with said API;
c) accessing at least one of information and rules indicative of an association between said application and one or more mapping modules; and
d) selecting one or more target mapping modules for use with said application based on said at least one of information and rules.

2. The method of claim 1, wherein step b) includes applying a predetermined set of rules.

3. The method of claim 2, wherein said predetermined set of rules includes association of an application type with said candidate mapping modules.

4. The method of claim 1, wherein step c) includes fetching system data through an internal control interface.

5. The method of claim 1, wherein step c) includes fetching rules from a database.

6. The method of claim 5, wherein said database is contained within said API.

7. The method of claim 5, wherein said rules include predetermined rules within said API.

8. The method of claim 1, further comprising:
mapping and associating the operations of the generic API to a specific implementation based on said selecting one or more target mapping modules.

9. The method of claim 1, further comprising:
accessing one or more management applications to obtain data for management of one or more API functions.

10. The method of claim 9, wherein said step of accessing includes using a management API module to access said one or more management applications.

11. The method of claim 10, wherein management API module is contained within said API.

12. The method of claim 1, further comprising:
updating a module registry to record an association between said application and one or more target mapping modules selected in step d).

13. The method of claim 1, wherein said information and rules are adapted to be dynamically updated.

14. The method of claim 13, wherein said information and rules include text-based encoding parsed at run-time.

15. The method of claim 13, wherein said information and rules include binary-based encoding parsed at run-time.

16. A program product, comprising machine readable program code for causing a machine to perform the following method steps:
a) receiving a mapping request, said mapping request having been triggered by an application;
b) selecting one or more candidate mapping modules from a group of registered mapping modules;
c) accessing at least one of information and rules indicative of an association between said application and one or more mapping modules; and
d) selecting one or more target mapping modules for use with said application based on said at least one of information and rules.

17. The program product of claim 16, wherein step b) includes applying a predetermined set of rules.

18. The program product of claim 17, wherein said predetermined set of rules includes association of an application type with said candidate mapping modules.

19. The program product of claim 16, wherein step c) includes fetching system data through an internal control interface.

20. The program product of claim 16, wherein step c) includes fetching rules from a database.

21. The program product of claim 20, wherein said database is contained within an API.

22. The program product of claim 20, wherein said rules include predetermined rules within an API.

23. The program product of claim 16, further comprising machine readable program code for causing a machine to perform the following method step:
mapping and associating the operations of the generic API to a specific implementation based on said selecting one or more target mapping modules.

24. The program product of claim 16, further comprising machine readable program code for causing a machine to perform the following method step:
accessing one or more management applications to obtain data for management of one or more API functions.

25. The program product of claim 24, wherein said step of accessing includes using a management API module to access said one or more management applications.

26. The program product of claim 25, wherein management API module is contained within said API.

27. The program product of claim 16, further comprising machine readable program code for causing a machine to perform the following method step:
updating a module registry to record an association between said application and one or more target mapping modules selected in step d).

28. The program product of claim 16, wherein said information and rules are adapted to be dynamically updated.

29. The program product of claim 28, wherein said information and rules include text-based encoding parsed at run-time.

30. The program product of claim 28, wherein said information and rules include binary-based encoding parsed at run-time.

31. An Application Program Interface (API) system, comprising:
a module registry adapted to manage attachment, detachment and tracking of mapping modules associated with one or more applications; and
a mapping module selector adapted to facilitate selection of one or more of said mapping modules in response to a mapping request triggered by an application.

32. The system of claim 31, wherein said mapping module selector is adapted to apply a predetermined set of rules.

33. The system of claim 32, wherein said predetermined set of rules includes association of an application type with one or more candidate mapping modules.

34. The system of claim 31, wherein said mapping module selector is adapted to fetch system data through an internal control interface.

35. The system of claim 31, wherein said mapping module selector is adapted to fetch rules from a database.

36. The system of claim 35, wherein said database is contained within said API.

37. An electronic device, comprising:
one or more application programs;
a processor adapted to execute said application programs; and
an application program interface (API), said API comprising:
a module registry adapted to manage attachment, detachment and tracking of mapping modules associated with said one or more applications; and
a mapping module selector adapted to facilitate selection of one or more of said mapping modules in response to a mapping request triggered by an application.

38. The electronic device of claim 37, wherein said mapping module selector is adapted to apply a predetermined set of rules.

39. The electronic device of claim 38, wherein said predetermined set of rules includes association of an application type with one or more candidate mapping modules.

40. The electronic device of claim 37, wherein said mapping module selector is adapted to fetch system data through an internal control interface.

41. The electronic device of claim 37, wherein said mapping module selector is adapted to fetch rules from a database.

42. The electronic device of claim 41, wherein said database is contained within said API.

43. The electronic device of claim 37, wherein said electronic device is a mobile device.

44. A computer implemented method of associating an event to one or more applications, the method comprising:
a) determining whether an event is associated with one or more active mapping modules, each mapping module being indicative of an API implementation;
b) identifying one or more applications associated with said one or more active mapping modules; and
c) notifying said one or more applications of said event.

45. The method of claim 44, wherein said event is at least one of an attachment and detachment of a mapping module.

46. The method of claim 44, wherein said event is generated by an application.

47. The method of claim 44, further comprising:
d) executing functionalities of said application based on said event.

48. A program product, comprising machine readable program code for causing a machine to perform the following method steps:
a) determining whether an event is associated with one or more active mapping modules, each mapping module being indicative of an API implementation;
b) identifying one or more applications associated with said one or more active mapping modules; and
c) notifying said one or more applications of said event.

49. The program product of claim 48, wherein said event is at least one of an attachment and detachment of a mapping module.

50. The program product of claim 48, wherein said event is generated by an application.

51. The program product of claim 48, further comprising machine readable program code for causing a machine to perform the following method step:
d) executing functionalities of said application based on said event.
